(19) United States
(12) Patent Application Publication
(10) Pub. No.: US 2003/0024574 A1
(43) Pub. Date: Feb. 6, 2003

(54) SAFETY VALVE FOR STEAM CLEANER

(76) Inventor: Samson Tsen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/922,154

(22) Filed: Aug. 6, 2001

(51) Int. Cl. F16K 17/04

(52) U.S. Cl. 137/510

(57) ABSTRACT

A safety valve installed in the water filling hole of the steam chamber of a steam cleaner and adapted to regular the inside pressure of the steam chamber, includes a valve body threaded into the water filling hole, a valve tube adapted to close/open the water filling hole subject to the steam pressure in the steam chamber, a driving disk fixedly fastened to the valve body, an actuating member fastened to the valve tube, a rotary cap adapted to rotate the valve body in and out of the water filling hole through the driving disk, and a clutch member adapted to control connection between the rotary cap and the driving disk subject to the presence of steam in the steam chamber.

### BACKGROUND OF THE INVENTION

The present invention relates to a steam cleaner, and more particularly, to a safety valve for steam cleaner that automatically regulates the pressure of the steam chamber of the steam cleaner, and is prohibited from dismounting when steam is produced in the steam chamber of the steam cleaner.

FIG. 6 shows a safety valve (pressure regulator) 3 installed in the water filling hole 22 of a steam cleaner 2 and adapted to regulate the pressure of the steam chamber of the steam cleaner 2 automatically. The safety valve 3 comprises a valve body 31 threaded into the water filling hole 22 of the steam cleaner 2, the valve body 31 having an air inlet 32 and an air outlet 35, a rotary cap 36 fastened to the valve body 31, a valve stopper 33 adapted to close the air outlet 35 of the valve body 31, and a spring 34 provided between the rotary cap 36 and the valve stopper 33 and imparting a downward pressure to the valve stopper 33 against the air outlet 35 of the valve body 31. Normally, the valve stopper 33 is forced by the spring 34 to close the air outlet 35. When the steam pressure of the steam chamber of the steam cleaner 2 surpasses the spring force of the spring 34, the valve stopper 33 is forced upwards from the air outlet 35 against the spring 34, enabling steam to exhaust through the air outlet 35. This structure of safety valve is functional, however it is not safe in use. When the user rotates the rotary cap 36 to disconnect the valve body 31 from the water filling hole 22 of the steam chamber 21 upon presence of steam in the steam chamber 21, steam immediately rushes out of the water filling hole 22, and a scalding accident may occur at this time.

### SUMMARY OF THE INVENTION

The present invention has been accomplished to provide a safety valve for steam cleaner, which eliminates the aforesaid problem. It is the main object of the present invention to provide a safety valve for steam cleaner, which automatically regulates the steam pressure of the steam cleaner, keeping the steam pressure within a predetermined level. It is another object of the present invention to provide a safety valve for steam cleaner, which prohibits the user from dismounting the safety valve upon presence of steam in the steam cleaner. To achieve these and other objects of the present invention, the safety valve comprises a valve body threaded into the water filling hole of the steam chamber of the steam cleaner, a valve tube adapted to close/open the water filling hole subject to the level of the steam pressure in the steam chamber, a driving disk fixedly fastened to the valve body, an actuating member fastened to the valve tube, a rotary cap adapted to rotate the valve body in and out of the water filling hole through the driving disk, and a clutch member adapted to control connection between the rotary cap and the driving disk subject to the presence of steam in the steam chamber.

### BRIEF DESCRIPTION OF THE DRAWINGS

FIG. 1A is an exploded view of a safety valve for steam cleaner according to the present invention.

FIG. 1B is a sectional elevation of the actuating member of the safety valve for steam cleaner according to the present invention.

FIG. 2 is a sectional assembly view of the safety valve for steam cleaner according to the present invention.

FIG. 3 is a sectional view of the present invention showing the diaphragm of the actuating member expanded, the clutch member disengaged from the driving disk.

FIG. 4 is a sectional view of the present invention showing the clutch member disengaged from the driving disk, steam passed out of the air outlet of the valve body to the outside of the steam cleaner.

FIG. 5 is an elevational view of a steam cleaner in which the safety valve of the present invention installed.

FIG. 6 is a sectional view of a safety valve installed in a steam cleaner according to the prior art.

### DETAILED DESCRIPTION OF THE PREFERRED EMBODIMENT

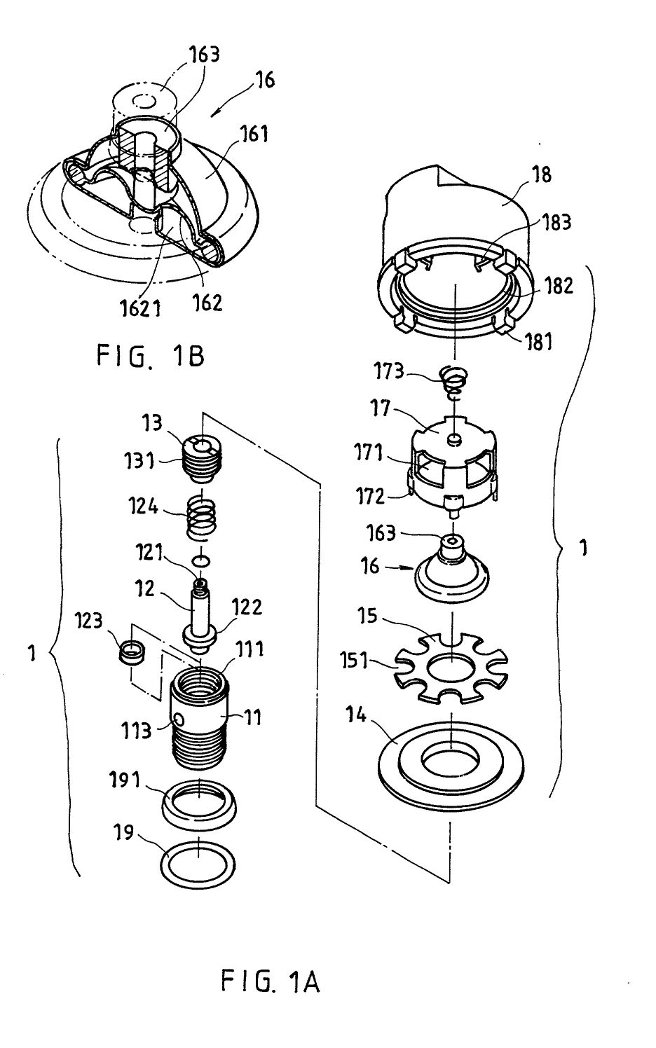

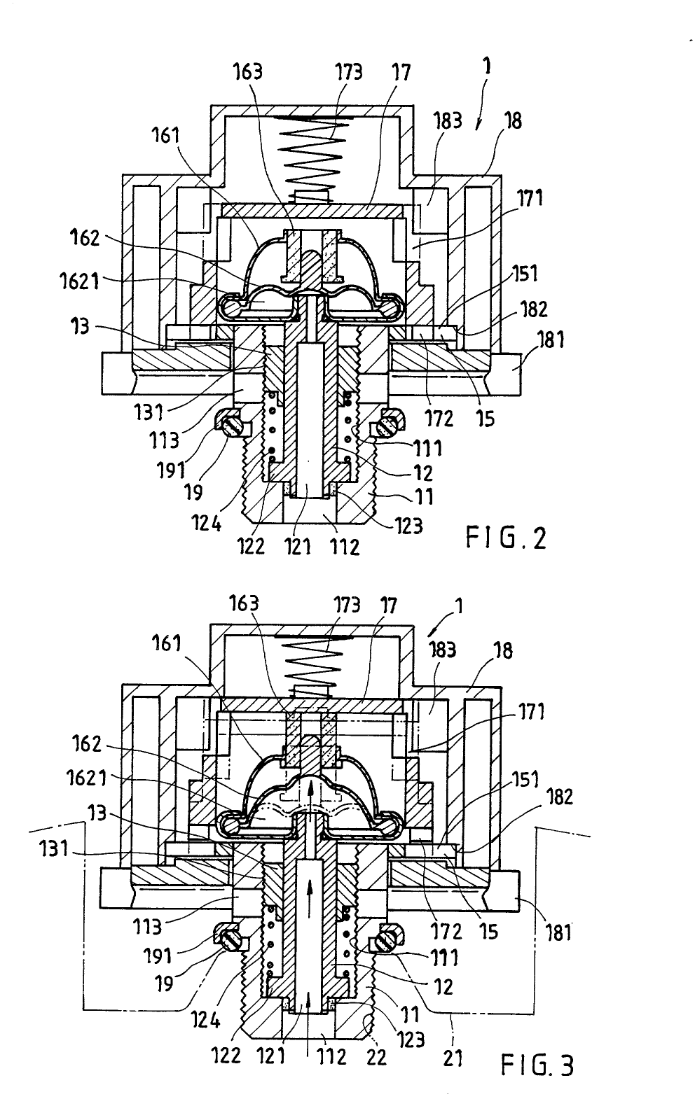

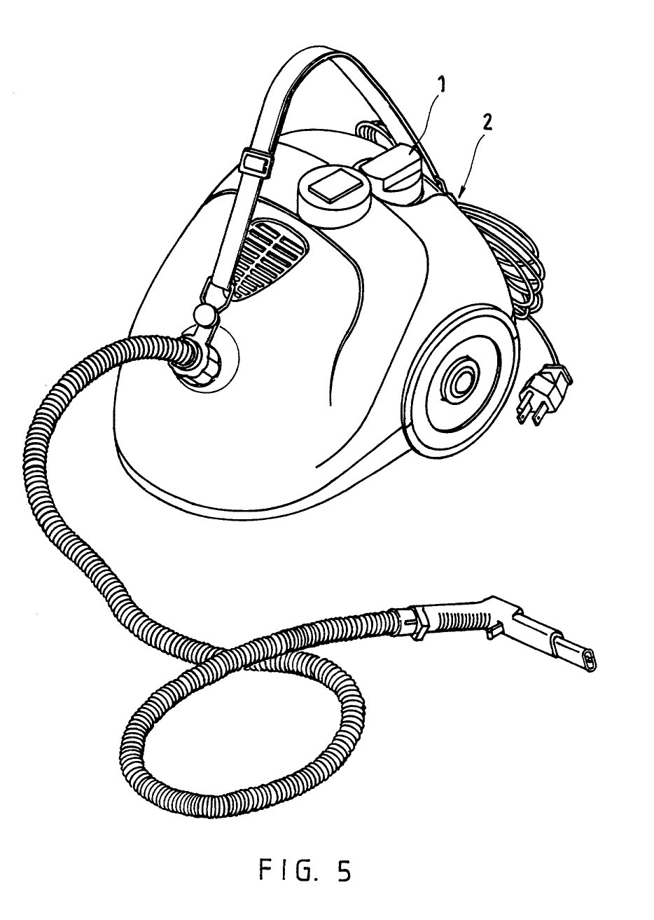

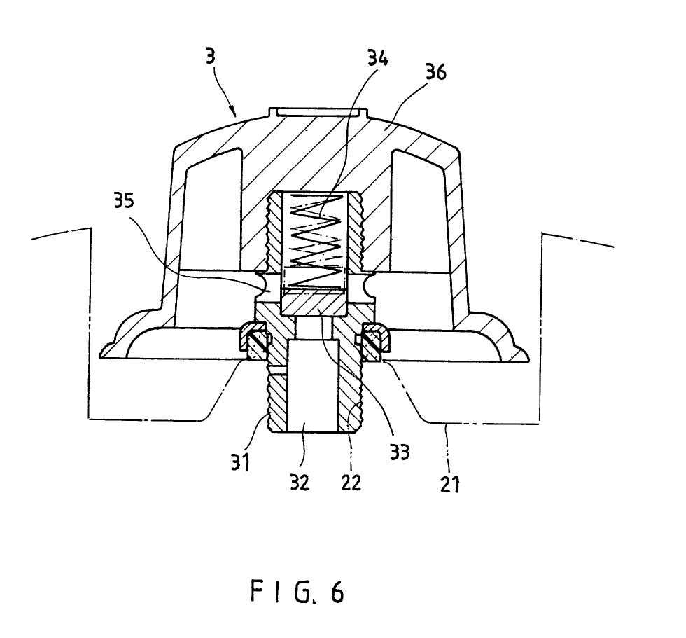

Referring to FIGS. 1A, 1B, 2, and 5, a safety valve 1 is used in a steam cleaner 2, comprising a hollow valve body 11. The valve body 11 comprises a center screw hole 111, a bottom air inlet 112 extended through the bottom sidewall thereof in communication with the center screw hole 111, an air outlet 113 transversely extended through the peripheral wall thereof in communication with the center screw hole 111. A valve tube 12 is mounted in the hollow valve body 11. The valve tube 12 has an axially extended center through hole 121 and a collar 122 around the periphery. A gasket ring 123 is fastened to the periphery of the bottom end of the valve tube 12 and adapted to seal the gap between the periphery of the valve tube 12 and the air inlet 112. A compression spring 124 is sleeved onto the valve tube 12 and supported on the collar 122. A hollow adjustment knob 13 is sleeved onto the valve tube 12 and fastened to the valve body 11 to hold down the compression spring 124, having an outer thread 131 threaded into the screw hole 111 of the valve body 11. The adjustment knob 13 is adapted to adjust the downward pressure of the compression spring 124 to the valve tube 12, to further regulate the air pressure in the steam chamber 21 of the steam cleaner 2. An actuating member 16 is threaded onto the externally threaded top end of the valve tube 12. The actuating member 16 comprises a shell 161, a diaphragm 162 suspended in the shell 161 and defining with the bottom sidewall of the shell 161 a bottom air chamber 1621 in communication with the axial center through hole 121 of the valve tube 12, and a push rod 163 upwardly extended from the center of the diaphragm 162 to the outside of the shell 161. A cushion 14 is provided around the valve body 11. A driving disk 15 is fixedly fastened to the periphery of the valve body 11 and supported on the cushion 14. The driving disk 15 has a plurality of peripheral notches 151. A rotary cap 18 is covered over the actuating member 16, comprising a plurality of bottom springy bottom hooks 181 respectively hooked on the periphery of the driving disk 15, an inside annular flange 182 supported on the driving disk 15, and a plurality of inside projections 183. A clutch member 17 is mounted in the rotary cap 18 around the actuating member 16. The clutch member 17 comprises a plurality of peripheral coupling holes 171 corresponding to the inside projections 183 of the rotary cap 18, and a plurality of legs 172 corresponding to the peripheral notches 151 of the driving disk 15. A compression spring 173 is provided between the rotary cap 18 and the clutch member 17 to force the clutch member 17 downwards from the rotary cap 18 into engagement with the driving disk 15. When rotating the rotary cap 18, the clutch member 17 is forced by the inside projections 183 of the rotary cap 18 to move with the rotary cap 18. Because the legs 172 are respectively engaged into the peripheral notches 151 of the driving disk 15 and the driving disk 15 is fixedly fastened to the valve body 11, rotating the clutch member 17 causes the valve body 11 to rotate with the clutch member 17. Therefore, the user can rotate the rotary cap 18 to disconnect the valve body 11 from the water filling hole 22 of the steam chamber 21 of the steam cleaner 2.

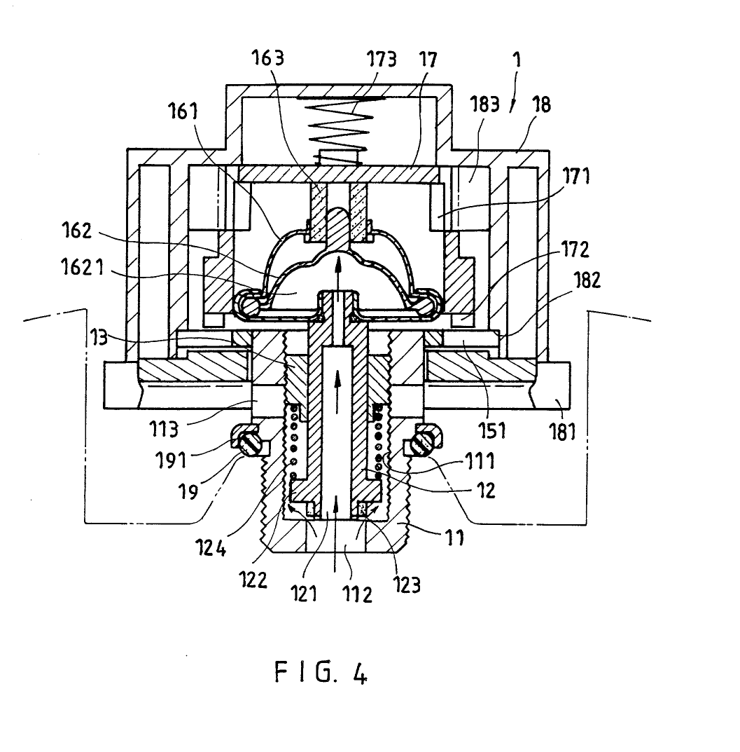

When the water in the steam chamber 21 is heated to the boiling point to produce a steam pressure, the steam pressure immediately passes through the air inlet 112 of the valve body 11 and the center through hole 121 of the valve tube 12 into the air chamber 1621 of the actuating member 16 to expand the diaphragm 162 and to further force the push rod 163 upward, thereby causing the push rod 163 to lift the clutch member 17 upwardly away from the driving disk 15. After disengagement of the legs 172 of the clutch member 17 from the peripheral notches 151 of the driving disk 15, the rotary motion of the rotary cap 18 does not drive the valve body 11 to rotate, i.e., the user cannot remove the safety valve 1 from the water filling hole 22 of the steam cleaner 2 when steam is produced in the steam chamber 21. When the inside pressure of the steam chamber 21 surpasses the spring power of the compression spring 124, the valve tube 12 is forced upwards from the air inlet 112 of the valve body 11 against the compression spring 124, enabling steam to pass through the air outlet 113 to the outside of the steam cleaner 2, keeping the inside pressure of the steam chamber 21 below the safety range (see FIG. 4). Further, a rubber ring holder 181 is fastened to the periphery of the valve body 11 to hold a gasket ring 19 that seals the gap between the periphery of the valve body 11 and the periphery of the water filling hole 22 of the steam chamber 21 of the steam cleaner 2.

It is to be understood that the drawings are designed for purposes of illustration only, and are not intended for use as a definition of the limits and scope of the invention disclosed.

What the invention claimed is:

1. A safety valve installed in the water filling hole of the steam chamber of a steam cleaner and adapted to regular the inside pressure of the steam chamber, comprising:
a valve body threaded into the water filling hole of the steam chamber of a steam cleaner, said valve body comprising a center screw hole, a bottom air inlet extended through the bottom sidewall thereof in communication with the center screw hole, an air outlet transversely extended through a peripheral wall thereof in communication with said center screw hole;
a valve tube mounted in said center screw hole of said valve body, said valve tube having an axially extended center through hole disposed in communication with said air inlet, and a collar extended around the periphery thereof;
a gasket ring fastened to the periphery of said valve tube and adapted to seal the gap between the periphery of said valve tube and said air inlet;
a first spring member sleeved onto said valve tube and supported on said collar and adapted to impart a downward pressure to said valve tube to force said gasket ring into engagement with said air inlet;
a hollow adjustment knob sleeved onto said valve tube and fastened to said valve body to hold down said first spring member on said collar of said valve tube, said adjustment knob having an outer thread threaded into said screw hole of said valve body;
an actuating member threaded onto said valve tube outside said valve body and adapted to detect the inside pressure of said steam chamber of said steam cleaner;
a fixed cushion mounted around said valve body;
a driving disk fixedly fastened to the periphery of said valve body and supported on said cushion, said driving disk having a plurality of peripheral notches;
a rotary cap covered over said actuating member, said rotary cap comprising a plurality of bottom springy bottom hooks respectively hooked on the periphery of said driving disk, and a plurality of inside projections;
a clutch member mounted in said rotary cap around said actuating member, said clutch member comprising a plurality of peripheral coupling holes respectively coupled to the inside projections of said rotary cap for enabling said clutch member to be rotated with said rotary cap, and a plurality of legs corresponding to the peripheral notches of said driving disk; and
a second spring member provided between said rotary cap and said clutch member to force said clutch member downwards from said rotary cap into engagement with said driving disk;
wherein when rotating said rotary cap in counter-clockwise direction before the presence of steam in said steam chamber, said actuating member is driven by said rotary cap to rotate said driving disk and said valve body, causing said valve body to be disconnected from said water filling hole of said steam cleaner; when steam is produced, it passes through said air inlet of said valve body and said axially extended center through hole of said valve tube to force said actuating member upwards, causing said actuating member to move said clutch member away from said driving disk so that said valve body is free from rotary motion of said rotary cap at this time; when the pressure of steam produced in said steam chamber surpasses a predetermined value, steam immediately forces said valve tube upwards from said air inlet and passes through said air outlet to the outside of said steam cleaner.

2. The safety valve as claimed in claim 1 wherein said actuating member comprises a shell, a diaphragm suspended in said shell and defining with a bottom sidewall of said shell a bottom air chamber in communication with the axial center through hole of said valve tube, and a push rod upwardly extended from the center of said diaphragm to the outside of said shell and stopped against a bottom side of said actuating member.

3. The safety valve as claimed in claim 1 wherein said rotary cap comprises an inside annular flange supported on said driving disk.
